(19) United States
(12) Patent Application Publication
(10) Pub. No.: US 2026/0107056 A1
(43) Pub. Date: Apr. 16, 2026

(54) IMAGING SYSTEM, IMAGING DEVICE, AND WEARABLE DEVICE

(71) Applicant: CANON KABUSHIKI KAISHA, Tokyo (JP)

(72) Inventor: TAKUMI TSUCHIYA, Kanagawa (JP)

(21) Appl. No.: 19/352,794

(22) Filed: Oct. 8, 2025

(30) Foreign Application Priority Data
Oct. 16, 2024 (JP) 2024-180588

(51) Int. Cl. H04N 23/62; G06F 3/01; H04N 23/66

(52) U.S. Cl. CPC H04N 23/62; G06F 3/016; H04N 23/66

(57) ABSTRACT

An imaging system according to the present disclosure includes an imaging device, and a wearable device, wherein the imaging device or the wearable device is configured to execute a determination process of determining a camera direction that is a direction from the wearable device to the imaging device, and wherein the imaging device or the wearable device is configured to execute a control process of performing control such that a user wearing the wearable device is notified of the camera direction by vibration of the wearable device in a case where the wearable device is within an imaging range of the imaging device.

### BACKGROUND

### Field of the Technology

The present disclosure relates to an imaging system, an imaging device, and a wearable device, and particularly, to a technology for linking the imaging device and the wearable device.

### Description of the Related Art

As wearable devices, there are wearable devices capable of giving haptics presentation. By giving haptics presentation, various types of information can be presented to the bodies of users coming in contact with the wearable devices. As haptics presentation, for example, tactile presentation or thermal presentation that presents force or motion by vibration, pressure, or the like is given.

Japanese Patent Laid-Open No. 2003-163822 discloses a technique in which a receiver receives radio waves from a transmitter of a camera and notifies a user of the receiver that an image is captured by the camera by vibration, a sound, an image, or the like.

However, in the technology of the related art disclosed in Japanese Patent Laid-Open No. 2003-163822, a user is merely notified that the image is captured by the camera. Therefore, even if the technology of the related art disclosed in Japanese Patent Laid-Open No. 2003-163822 is used, the user cannot easily ascertain from which direction an image is captured when the user does not know a position of the camera. Japanese Patent Laid-Open No. 2003-163822 also discloses that positional information of a camera and image information of a place where the camera is installed are transmitted to a receiver. However, even if these pieces of information are used, a user who is not familiar with the place or the like cannot easily ascertain the position of the camera.

### SUMMARY

The present disclosure provides a technique to enable a user to easily ascertain a direction of an imaging device that captures an image of the user.

The present disclosure its first aspect provides an imaging system including an imaging device, and a wearable device, wherein the imaging device or the wearable device is configured to execute a determination process of determining a camera direction that is a direction from the wearable device to the imaging device, and wherein the imaging device or the wearable device is configured to execute a control process of performing control such that a user wearing the wearable device is notified of the camera direction by vibration of the wearable device in a case where the wearable device is within an imaging range of the imaging device.

The present disclosure its second aspect provides an imaging device in an imaging system comprising the imaging device and a wearable device, wherein the imaging device or the wearable device is configured to execute a determination process of determining a camera direction that is a direction from the wearable device to the imaging device, and wherein the imaging device is configured to execute a control process of performing control such that a user wearing the wearable device is notified of the camera direction by vibration of the wearable device in a case where the wearable device is within an imaging range of the imaging device.

The present disclosure its third aspect provides a wearable device in an imaging system comprising an imaging device and a wearable device, wherein the imaging device or the wearable device is configured to execute a determination process of determining a camera direction that is a direction from the wearable device to the imaging device, and wherein the wearable device is configured to execute a notification process of notifying a user wearing the wearable device of the camera direction by vibration of the wearable device in a case where the wearable device is within an imaging range of the imaging device.

The present disclosure its fourth aspect provides a control method of an imaging system including an imaging device and a wearable device, the control method comprising determining a camera direction that is a direction from the wearable device to the imaging device, and performing control such that a user wearing the wearable device is notified of the camera direction by vibration of the wearable device in a case where the wearable device is within an imaging range of the imaging device.

The present disclosure its fifth aspect provides a non-transitory computer readable medium that stores a program, wherein the program causes a computer to execute a control method of an imaging system including an imaging device and a wearable device, the control method comprising determining a camera direction that is a direction from the wearable device to the imaging device, and performing control such that a user wearing the wearable device is notified of the camera direction by vibration of the wearable device in a case where the wearable device is within an imaging range of the imaging device.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of an imaging system according to a first embodiment.

FIGS. 2A and 2B are external views of the imaging device according to the first embodiment.

FIG. 3 is a flowchart illustrating an operation example of the imaging system according to the first embodiment.

FIG. 4 is a schematic diagram illustrating an operation example of the imaging system according to the first embodiment.

FIG. 5 is a schematic diagram illustrating an operation example of a wearable device according to the first embodiment.

FIGS. 6A to 6D are schematic diagrams illustrating an operation example of the imaging system according to the first embodiment.

FIG. 7 is a schematic diagram when a drone is used as the imaging device.

FIG. 8 is a flowchart illustrating an operation example of an imaging system according to a second embodiment.

FIG. 9 is a schematic diagram illustrating an operation example of the imaging system according to the second embodiment.

FIG. 10 is a block diagram illustrating a configuration example of an imaging system according to a third embodiment.

FIG. 11 is a flowchart illustrating an operation example of the imaging system according to the third embodiment.

### DESCRIPTION OF THE EMBODIMENTS

### First Embodiment

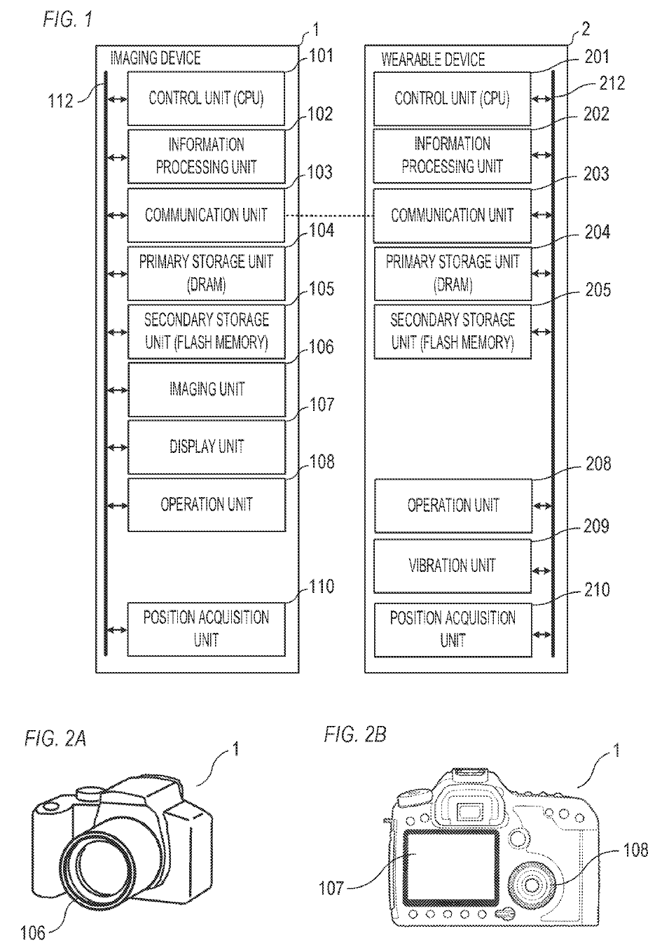

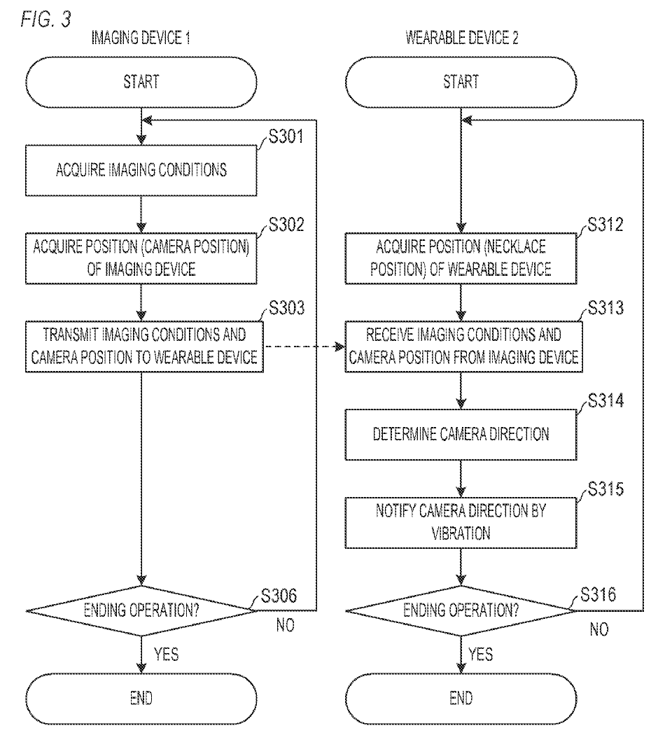

A first embodiment of the present disclosure will be described. FIG. 1 is a block diagram illustrating a configuration example of an imaging system according to a first embodiment. The imaging system in FIG. 1 includes an imaging device 1 and a wearable device 2. FIGS. 2A and 2B are external views of the imaging device 1. FIG. 2A is a front view (front perspective view) of the imaging device 1, and FIG. 2B is a rear view of the imaging device 1.

The imaging device 1 includes a control unit 101, an information processing unit 102, a communication unit 103, a primary storage unit 104, a secondary storage unit 105, an imaging unit 106, a display unit 107, an operation unit 108, and a position acquisition unit 110. These constituents are connected to a bus 112, and data is transmitted and received between the constituents via the bus 112.

The control unit 101 is, for example, a CPU and controls each unit (the information processing unit 102, the communication unit 103, the primary storage unit 104, the secondary storage unit 105, the imaging unit 106, the display unit 107, the operation unit 108, the position acquisition unit 110, and the like) of the imaging device 1.

The information processing unit 102 is a processing circuit (arithmetic unit) that performs various types of information processing (arithmetic processing). For example, the information processing unit 102 performs arithmetic processing of image data obtained by the imaging unit 106 (arithmetic processing for obtaining various evaluation values of the image data, and the like). The information processing unit 102 also performs arithmetic processing of data obtained by the communication unit 103, arithmetic processing of position data obtained by the position acquisition unit 110, and the like.

The communication unit 103 is a communication interface that communicates with an external device.

The primary storage unit 104 is, for example, a DRAM and temporarily stores data used by the control unit 101 and the information processing unit 102.

The secondary storage unit 105 is, for example, a flash memory and stores data used by the control unit 101 and the information processing unit 102, a processing result (for example, an encoded recorded image) of the information processing unit 102, and the like.

The imaging unit 106 includes, for example, an optical lens, an imaging element (image sensor), and an A/D converter and converts light from the outside (object) into digital data (image data).

The display unit 107 is a display that displays various images. The display unit 107 may have a touch panel that receives a touch operation with a user's finger, a stylus, or the like.

The operation unit 108 includes an operation member that receives a user operation and includes, for example, a button and a dial. The above-described touch panel is also an example of the operation member. When a user operation is performed on the operation members, the control unit 101 performs control in response to the user operation. The communication unit 103 may acquire a signal in response to a user operation on the external device, and the control unit 101 may perform control in accordance with a signal.

The position acquisition unit 110 includes, for example, a receiver of a global positioning system (GPS) and acquires a current position (position data) of the imaging device 1.

In the first embodiment, the imaging device 1 is a camera (digital camera), but the imaging device 1 may be a smartphone, a tablet terminal, or the like. The imaging device 1 may be an automatic imaging camera. The imaging device 1 may be able to rotate at an angle of view around at least one of a pan axis, a tilt axis, and a roll axis in addition to zooming and driving (changing) an iris. The rotation of an angle of view around the pan axis and the tilt axis can be implemented by adjusting an angle of the entire optical system including the optical lens and the imaging element. The rotation of an angle of view around the roll axis can be implemented by adjusting an angle of the imaging element. The imaging device 1 may be driven (moved) in at least any one of up and down directions, left and right directions, and front and rear directions. The imaging device 1 itself may be able to move or rotate like a drone. External equipment such as a movable platform such as a gimbal may be mounted to be detachable from the imaging device 1.

The wearable device 2 includes a control unit 201, an information processing unit 202, a communication unit 203, a primary storage unit 204, a secondary storage unit 205, an operation unit 208, a vibration unit 209, and a position acquisition unit 210. The constituents are connected to a bus 212, and data is transmitted and received between the constituents via the bus 212.

The control unit 201 is, for example, a CPU and controls each unit (the information processing unit 202, the communication unit 203, the primary storage unit 204, the secondary storage unit 205, the operation unit 208, the vibration unit 209, the position acquisition unit 210, and the like) of the wearable device 2.

The information processing unit 202 is a processing circuit (arithmetic unit) that performs various types of information processing (arithmetic processing). For example, the information processing unit 202 performs arithmetic processing of data obtained by the communication unit 203, arithmetic processing of position data obtained by the position acquisition unit 210, and the like.

The communication unit 203 is a communication interface that communicates with an external device.

The primary storage unit 204 is, for example, a DRAM, and temporarily stores data used by the control unit 201 and the information processing unit 202.

The secondary storage unit 205 is, for example, a flash memory and stores data used by the control unit 201 and the information processing unit 202, a processing result of the information processing unit 202, and the like.

The operation unit 208 includes an operation member that receives a user operation and includes, for example, a button and a dial. When a user operation is performed on the operation members, the control unit 201 performs control in response to the user operation. The communication unit 203 may acquire a signal in response to a user operation on the external device, and the control unit 201 may perform control in accordance with a signal.

The vibration unit 209 vibrates the wearable device 2. For example, the vibration unit 209 can notify the user wearing the wearable device 2 of a direction by vibrating a part of the wearable device 2, and can change the direction of the notification to the user by changing the portion to be vibrated.

The position acquisition unit 210 includes, for example, a receiver of a GPS and acquires a current position (position data) of the wearable device 2.

In the first embodiment, the wearable device 2 is a necklace-type device, but the wearable device 2 may be another device that comes into contact with a user's skin in a certain wide range. For example, the wearable device 2 may be a glove type device, a wristband type device, a belt type device, or the like. The wearable device 2 may be a smartwatch, a smartphone, a head mounted display (HMD), or the like. The wearable device 2 may be a non-contact device capable of notifying a direction using an ultrasonic wave or the like without coming into contact with the skin of the user. The wearable device 2 is not a simple vibration device, and may be a device that can make the user feel a traction force.

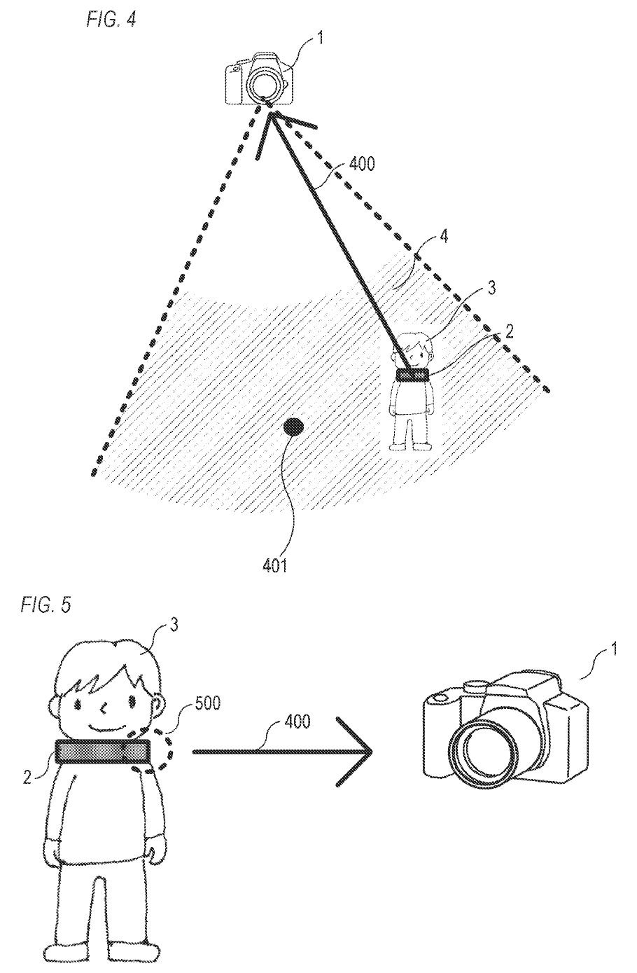

FIG. 3 is a flowchart illustrating an operation example of the imaging system according to the first embodiment. FIG. 4 is a schematic diagram illustrating an operation example of the imaging system according to the first embodiment.

An operation of the imaging device 1 starts in response to a user operation on the operation unit 108 of the imaging device 1.

In S301 of FIG. 3, the control unit 101 of the imaging device 1 acquires imaging conditions indicating an imaging view angle, a focus range, an imaging state, and the like, and stores the imaging conditions in the primary storage unit 104.

In S302, the control unit 101 uses the position acquisition unit 110 to acquire a camera position (X1, Y1, Z1) that is a current position of the imaging device 1, and stores the camera position in the primary storage unit 104.

In S303, the control unit 101 transmits the imaging conditions and the camera position (X1, Y1, Z1) stored in the primary storage unit 104 to the wearable device 2 using the communication unit 103.

In S306, the control unit 101 determines whether an ending operation that is a user operation of ending an operation of the imaging device 1 has been performed on the operation unit 108. When the ending operation has been performed, the operation of the imaging device 1 ends. Otherwise, the process proceeds to S301.

Similarly to the imaging device 1, the operation of the wearable device 2 starts in response to the user operation on the operation unit 208 of the wearable device 2.

In S312, the control unit 201 of the wearable device 2 uses the position acquisition unit 210 to acquire a necklace position (X2, Y2, Z2) that is a current position of the wearable device 2, and stores the necklace position in the primary storage unit 204.

In S313, the control unit 201 receives the imaging conditions and the camera position (X1, Y1, Z1) from the imaging device 1 using the communication unit 203, and stores the imaging conditions and the camera position in the primary storage unit 204.

In S314, the control unit 201 uses the information processing unit 202 to determine a camera direction (direction 400 in FIG. 4) that is a direction from the wearable device 2 (a necklace position, the object 3 in FIG. 4) to the imaging device 1 (camera position). The camera direction 400 is determined based on the camera position (X1, Y1, Z1) and the necklace position (X2, Y2, Z2) stored in the primary storage unit 204.

Further, in S314, the control unit 201 determines a imaging range 4 (a range having the position (X3, Y3, Z3) as a barycenter 401 (barycentric position)) of the imaging device 1 illustrated in FIG. 4 using the information processing unit 202. The imaging range 4 is determined based on the imaging conditions stored in the primary storage unit 204 and the camera position (X1, Y1, Z1). In FIG. 4, the imaging range 4 is assumed to be a focus range, but the imaging range 4 may be the entire range to be imaged or a part of a range to be imaged. The imaging range 4 may be narrower or wider than the focus range.

Then, when the wearable device 2 (a necklace position, the object 3 in FIG. 4) is within the imaging range 4, the control unit 201 stores the camera direction 400 in the primary storage unit 204. On the other hand, when the wearable device 2 is not within the imaging range 4, the control unit 201 stores information indicating that there is no camera direction 400 in the primary storage unit 204 so that the camera direction 400 is not notified of (as described below). Even when the imaging device 1 is on imaging standby (not imaging), information indicating that there is no camera direction 400 may be stored in the primary storage unit 204.

The camera direction 400 may be determined only when the wearable device 2 is within the imaging range 4.

In S315, the control unit 201 notifies the object 3 wearing the wearable device 2 of the camera direction 400 stored in the primary storage unit 204 using the vibration unit 209. FIG. 5 is a schematic diagram illustrating an operation example of the wearable device 2 in S315. The vibration unit 209 notifies the object 3 of the camera direction 400 by vibrating a portion 500 corresponding to the camera direction 400. For example, when the object 3 (wearable device 2) faces in the camera direction 400, the notification is stopped.

The vibration unit 209 may change a vibration pattern (for example, a vibration intensity or a vibration cycle) of the wearable device 2 in accordance with the distance from the wearable device 2 to the imaging device 1. For example, the vibration unit 209 may vibrate the wearable device 2 with a stronger vibration intensity or a shorter vibration cycle as the wearable device 2 is closer to the imaging device 1. In this way, the object 3 can ascertain a sense of distance as to whether the object 3 is close to or far from the imaging device 1. The control unit 201 may notify the distance from the wearable device 2 to the imaging device 1 by a notification method different from the vibration of the wearable device 2. For example, when the wearable device 2 includes a temperature generation unit, the control unit 201 may change the temperature of the wearable device 2 according to the distance from the wearable device 2 to the imaging device 1 using the temperature generation unit.

In S316, the control unit 201 determines whether an ending operation that is a user operation of ending the operation of the wearable device 2 is performed on the operation unit 208. When the ending operation is performed, the operation of the wearable device 2 ends. Otherwise, the process proceeds to S312.

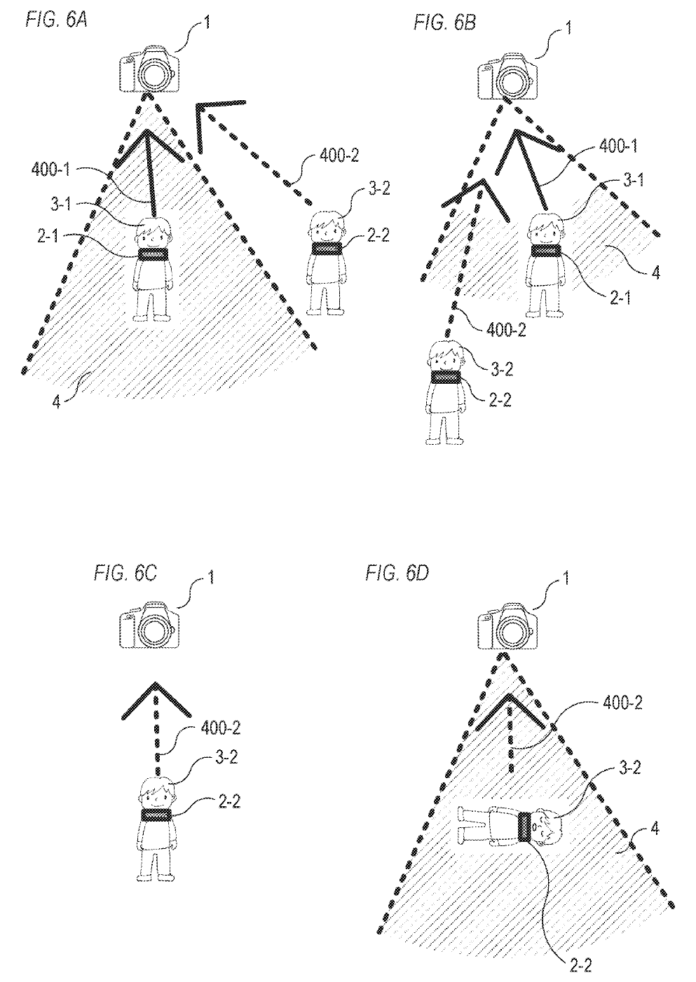

FIGS. 6A to 6D are schematic diagrams illustrating an operation example of the imaging system according to the first embodiment.

FIG. 6A illustrates an example in which an entire range to be imaged is used as the imaging range 4. In FIG. 6A, an object 3-1 on which the wearable device 2-1 is worn is included in the imaging range 4, but an object 3-2 on which the wearable device 2-2 is worn is not included in the imaging range 4. In this case, the object 3-1 is notified of a camera direction 400-1 from the object 3-1 to the imaging device 1, but the object 3-2 is not notified of a camera direction 400-2 from the object 3-2 to the imaging device 1.

FIG. 6B illustrates an example in which the focus range is used as the imaging range 4. In FIG. 6B, the object 3-1 on which the wearable device 2-1 is worn is included in the imaging range 4, but the object 3-2 on which the wearable device 2-2 is worn is not included in the imaging range 4. Even in this case, the object 3-1 is notified of the camera direction 400-1 from the object 3-1 to the imaging device 1, but the object 3-2 is not notified of the camera direction 400-2 from the object 3-2 to the imaging device 1.

As described above, information indicating that there is no camera direction 400 may be stored in the primary storage unit 204 so that notification of the camera direction 400 (as described below) is not performed when the imaging device 1 is on imaging standby (not imaging). In FIG. 6C, the object 3-2 on which the wearable device 2-2 is worn is included in the imaging range 4 (not illustrated), but the imaging device 1 is on imaging standby. Therefore, the object 3-2 is not notified of the camera direction 400-2 from the object 3-2 to the imaging device 1.

When the state of the object 3 is the predetermined state, the camera direction 400 may not be notified of by the vibration of the wearable device 2 may not be performed. A method of detecting the state of the object 3 is not particularly limited. However, for example, the information processing unit 202 may detect a state of the object 3 based on a temporal change in a position of the wearable device 2 obtained by the position acquisition unit 210. The predetermined state is also not particularly limited. For example, the predetermined state is a state in which notification by vibration becomes troublesome for the object 3, and includes at least one of a state in which the object 3 moves with intensity greater than a predetermined threshold, a state in which the object 3 is sleeping, and a state in which the object 3 is talking. In FIG. 6D, the object 3-2 on which the wearable device 2-2 is worn is included in the imaging range 4, but the object 3-2 is sleeping. Therefore, the object 3-2 is not notified of the camera direction 400-2 from the object 3-2 to the imaging device 1.

As described above, according to the first embodiment, the camera direction 400 from the wearable device 2 to the imaging device 1 is determined, and the object 3 is notified of the camera direction 400 by the vibration of the wearable device 2. In this way, the object 3 can easily ascertain the direction of the imaging device 1 that captures an image of the object 3, and can immediately perform an operation such as directing the line of sight to the imaging device 1 or taking a pose. The position of the imaging device 1, the position of the wearable device 2, and the imaging conditions (such as the imaging range 4) change from moment to moment. However, since the camera direction 400 is updated in real time, the portion 500 vibrated by the vibration unit 209 also changes from moment to moment. Accordingly, the object 3 can ascertain the camera direction 400 in real time.

When the camera direction 400 is notified by sound, unintended sound may be included in a captured (recorded) moving image, or the object 3 may not be able to grasp the notification of the camera direction 400 due to noise. When the camera direction 400 is notified by an image, the movement of the line of sight of the object 3 is uncomfortable. In the first embodiment, since the camera direction 400 is notified of by vibration, these problems do not occur.

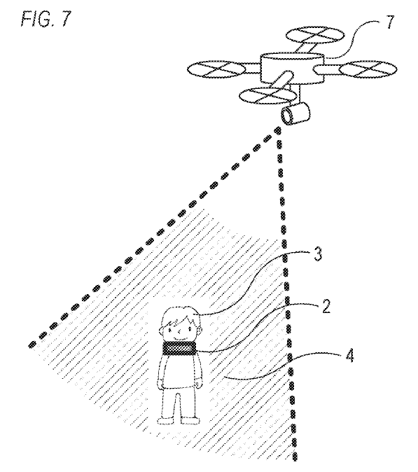

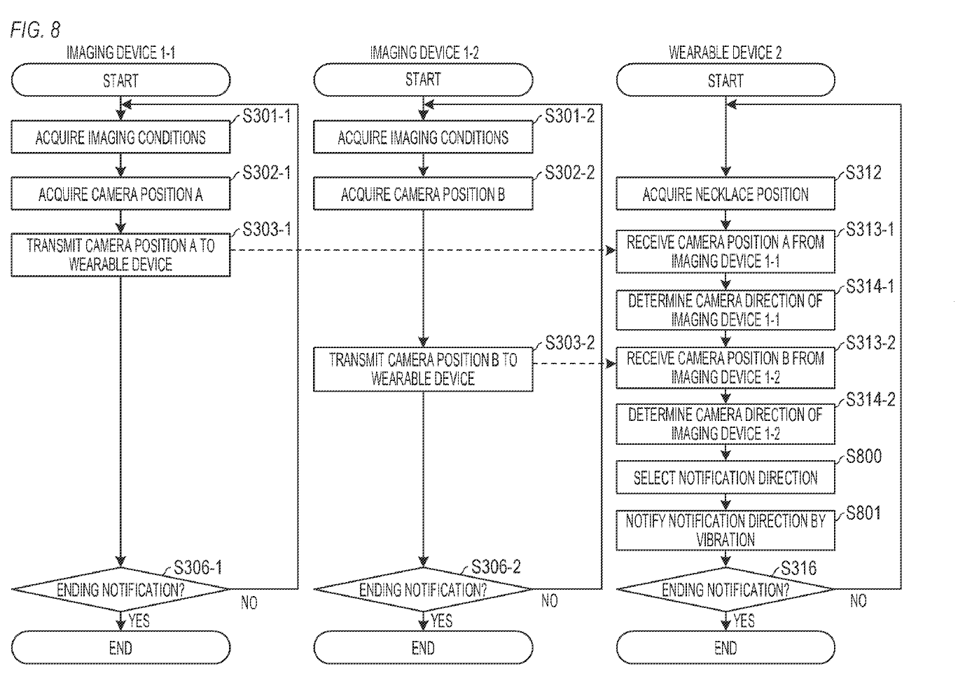

As described above, the imaging device 1 may be a drone. FIG. 7 is a schematic diagram illustrating a state in which object 3 performs selfie imaging by automatic imaging using drone 7 as imaging device 1. In the automatic capturing of the drone 7, since the position of the drone 7 changes from moment to moment, the object 3 may lose sight of the drone 7. However, since the wearable device 2 notifies of the camera direction 400 in real time, the object 3 can ascertain the camera direction 400 in real time.

The control unit 201 may be able to select one or more of a plurality of notification methods including vibration of the wearable device 2 and notify the object 3 of the camera direction 400 and the like by the selected notification method. When the state of the object 3 is a predetermined state, the control unit 201 may notify the object 3 of the camera direction 400 by a notification method different from the vibration of the wearable device 2. The plurality of notification methods include, for example, at least one of an output of sound, display of an image, a change in temperature, and generation of smell.

The notification of the camera direction 400 may be performed when a still image is captured or when a moving image is captured. The camera direction 400 may be notified of when the user of the imaging device 1 and the user of the wearable device 2 perform the same selfie imaging, or may be performed when the user of the imaging device 1 and the user of the wearable device 2 perform different selfie imaging. The user of the imaging device 1 or the wearable device 2 may be able to set whether to perform the notification of the camera direction 400.

At least one of the plurality of processes (a plurality of types of control) described as being performed by the wearable device 2 may be performed by the imaging device 1 or may be performed by another external device such as a cloud server. Similarly, at least one of the plurality of processes (a plurality of types of control) described as being performed by the imaging device 1 may be performed by the wearable device 2 or may be performed by another external device such as a cloud server. For example, the wearable device 2 may transmit necessary information to the imaging device 1, and the information processing unit 102 of the imaging device 1 may determine the camera direction 400.

### Second Embodiment

A second embodiment of the present disclosure will be described. In the following description, configurations and processes similar to those of the first embodiment will not be described, and configurations and processes different from those of the first embodiment will be described.

In the first embodiment, as described above, the imaging system includes one imaging device. In the second embodiment, it is assumed that the imaging system includes a plurality of imaging devices. In this case, one wearable device may be within the imaging range of each of the plurality of imaging devices. In the second embodiment, when one wearable device is within an imaging range of each of a plurality of imaging devices, an object wearing the wearable device is notified of at least one of a plurality of camera directions respectively corresponding to the plurality of imaging devices.

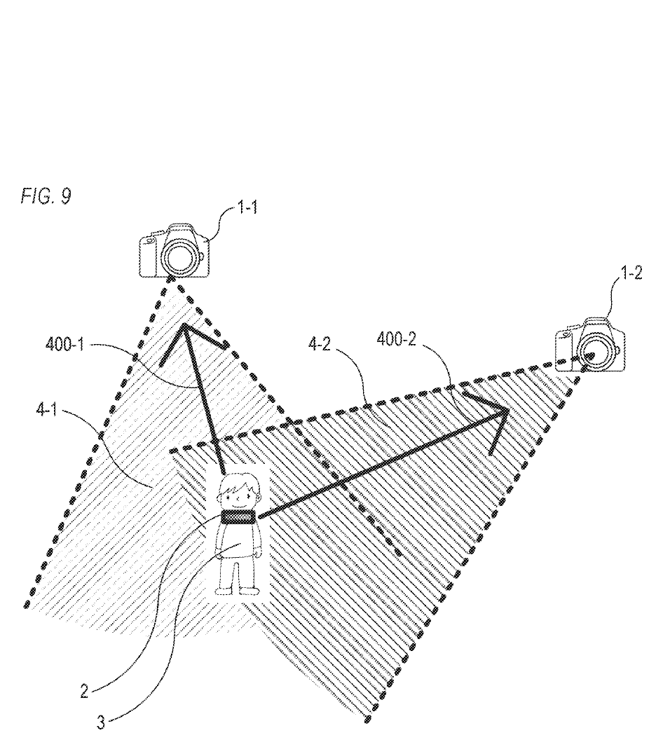

FIG. 8 is a flowchart illustrating an operation example of an imaging system according to a second embodiment. FIG. 9 is a schematic diagram illustrating an operation example of the imaging system according to the second embodiment. Imaging devices 1-1 and 1-2 have the same configuration as the imaging device 1 according to the first embodiment.

An operation of the imaging device 1-1 (S301-1 to S303-1 and S306-1 in FIG. 8) is similar to the operation of the imaging device 1 according to the first embodiment (S301 to S303 and S306 in FIG. 3). An operation of the imaging device 1-2 (S301-2 to S303-2 and S306-2 in FIG. 8) is also similar to the operation of the imaging device 1 according to the first embodiment (S301 to S303 and S306 in FIG. 3).

In the operation of the wearable device 2 illustrated in FIG. 8, similarly to the first embodiment (FIG. 3), in S312, the control unit 201 acquires a necklace position that is a current position of the wearable device 2, and stores the necklace position in the primary storage unit 204.

Similarly to S313 of the first embodiment (FIG. 3), in S313-1, the control unit 201 receives the imaging conditions and the camera position of the imaging device 1-1 from the imaging device 1-1, and stores the imaging conditions and the camera position in the primary storage unit 204. Hereinafter, the camera position of the imaging device 1-1 is referred to as a camera position A.

Similarly to S314 of the first embodiment (FIG. 3), in S314-1, the control unit 201 determines the camera direction (direction 400-1 in FIG. 9) that is the direction from the wearable device 2 (a necklace position, the object 3 in FIG. 9) to the imaging device 1-1 (camera position A). Further, in S314-1, the control unit 201 determines the imaging range 4-1 of the imaging device 1-1 illustrated in FIG. 9. Then, when the wearable device 2 (a necklace position, the object 3 in FIG. 9) is within the imaging range 4-1, the control unit 201 stores the camera direction 400-1 in the primary storage unit 204. On the other hand, when the wearable device 2 is not within the imaging range 4-1, the control unit 201 stores information indicating that there is no camera direction 400-1 in the primary storage unit 204 so that the camera direction 400-1 is not notified of.

Similarly to S313 of the first embodiment (FIG. 3), in S313-2, the control unit 201 receives the imaging conditions and the camera position of the imaging device 1-2 from the imaging device 1-2, and stores the imaging conditions and the camera position in the primary storage unit 204. Hereinafter, the camera position of the imaging device 1-2 is referred to as a camera position B.

Similarly to S314 of the first embodiment (FIG. 3), in S314-2, the control unit 201 determines the camera direction (direction 400-2 in FIG. 9) that is the direction from the wearable device 2(Necklace position, the object 3 in FIG. 9) to the imaging device 1-2 (camera position B). Further, in S314-2, the control unit 201 determines an imaging range 4-2 of the imaging device 1-2 illustrated in FIG. 9. Then, when the wearable device 2 (a necklace position, the object 3 in FIG. 9) is within the imaging range 4-2, the control unit 201 stores the camera direction 400-2 in the primary storage unit 204. On the other hand, when the wearable device 2 is not within the imaging range 4-2, the control unit 201 stores information indicating that there is no camera direction 400-2 in the primary storage unit 204 so that the camera direction 400-2 is not notified of.

In S800, the control unit 201 uses the information processing unit 202 to select at least one of the camera directions 400-1 and 400-2 stored in the primary storage unit 204 as the notification direction.

In S801, the control unit 201 notifies the object 3 wearing the wearable device 2 of the notification direction selected in S800 using the vibration unit 209.

Here, as illustrated in FIG. 9, a case where the object 3 on which the wearable device 2 is worn is included in both the imaging range 4-1 of the imaging device 1-1 and the imaging range 4-2 of the imaging device 1-2 will be considered. In this case, the object 3 may be notified of only one of the camera directions 400-1 and 400-2, or the object 3 may be notified of both the camera directions 400-1 and 400-2. For example, the control unit 201 may set priority of the imaging device 1-1 and priority of the imaging device 1-2 in advance. Then, in S800, the control unit 201 may select the camera direction as the notification direction such that the object 3 is notified of only the camera direction corresponding to the imaging device having priority higher than a predetermined threshold between the camera directions 400-1 and 400-2.

A priority setting method is not particularly limited. For example, the control unit 201 may set the priority of the imaging device 1-1 based on at least one of an instruction from a user (the object 3 or the photographer), a distance from the wearable device 2 to the imaging device 1-1, and a composition of an image captured by the imaging device 1-1. The priority of the imaging device 1-2 may also be set by a similar method. The control unit 201 may individually set the priority of the imaging device 1-1 and the priority of the imaging device 1-2 in response to a user operation on the operation unit 208. Higher priority may be set as a distance from the wearable device 2 to the imaging device is shorter. Higher priority may be set as a position of the object 3 in the captured image is closer to an optimum position from the viewpoint of the composition. The optimum position from the viewpoint of the composition is determined for each captured image.

When the object 3 is notified of both the camera directions 400-1 and 400-2, a vibration pattern for notifying the camera direction 400-1 may be different from a vibration pattern for notifying the camera direction 400-2. For example, the control unit 201 vibrates a portion corresponding to the camera direction 400-1 in the wearable device 2 at a short vibration cycle, and vibrates a portion corresponding to the camera direction 400-2 at a long vibration cycle. In this way, the object 3 can distinguish and ascertain the camera direction 400-1 and the camera direction 400-2.

The control unit 201 may notify the object 3 of both the camera directions 400-1 and 400-2 by vibrating a portion corresponding to an intermediate direction (average direction) between the camera directions 400-1 and 400-2 in the wearable device 2.

The description returns to FIG. 8. Similarly to the first embodiment (FIG. 3), in S316, the control unit 201 determines whether the ending operation that is a user operation of ending the operation of the wearable device 2 is performed on the operation unit 208. When the ending operation is performed, the operation of the wearable device 2 ends. Otherwise, the process proceeds to S312.

As described above, according to the second embodiment, the object to which the plurality of imaging devices are directed is notified of at least one of the plurality of camera directions respectively corresponding to the plurality of imaging devices. In this way, the object 3 can easily ascertain at least one of the directions of the plurality of imaging devices, and can immediately perform an operation such as directing the line of sight or taking a pose on the imaging device for which the object 3 ascertained. Although the example in which two imaging devices are used has been described, three or more imaging devices may be used.

### Third Embodiment

A third embodiment of the present disclosure will be described. In the following description, configurations and processes similar to those of the first embodiment will not be described, and configurations and processes different from those of the first embodiment will be described.

In the first embodiment, as described above, the position of the imaging device 1 and the position of the wearable device 2 are acquired using the GPS. However, in that case, it is necessary to provide GPS receivers in both the imaging device 1 and the wearable device 2. In the third embodiment, the position of the imaging device 1 and the position of the wearable device 2 are acquired without using the GPS.

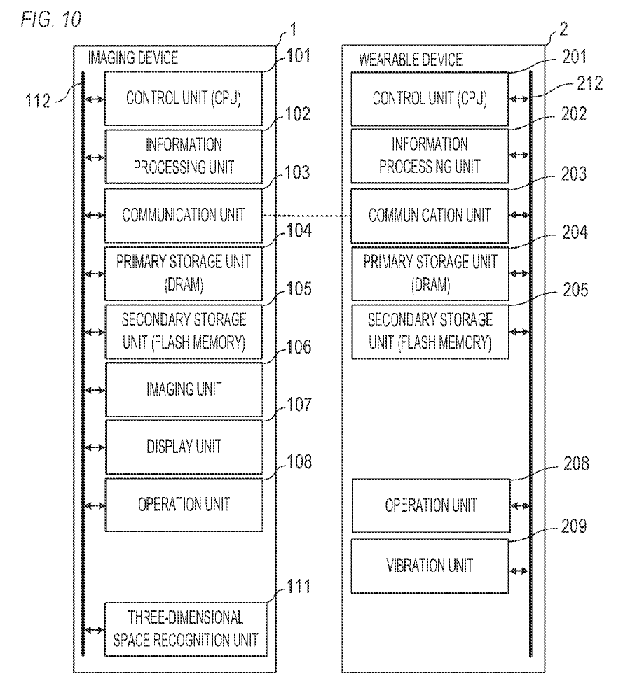

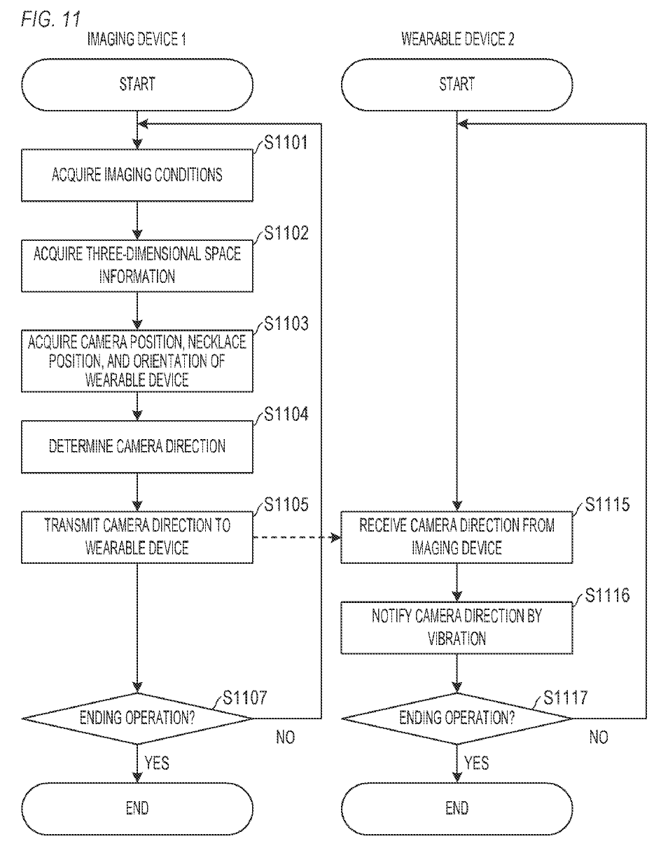

FIG. 10 is a block diagram illustrating a configuration example of an imaging system according to a third embodiment, and In the third embodiment, the imaging device 1 does not include the position acquisition unit 110 according to the first embodiment (FIG. 1), and the wearable device 2 does not include the position acquisition unit 210 according to the first embodiment (FIG. 1). Instead, the imaging device 1 includes a three-dimensional space recognition unit 111. The three-dimensional space recognition unit 111 includes a distance sensor and the like, and acquires (recognizes) distance information of the real space.

FIG. 11 is a flowchart illustrating an operation example of the imaging system according to the third embodiment.

An operation of the imaging device 1 starts in response to a user operation on the operation unit 108 of the imaging device 1.

In S1101 of FIG. 11, the control unit 101 of the imaging device 1 acquires the imaging conditions and stores the imaging conditions in the primary storage unit 104.

In S1102, the control unit 101 uses the three-dimensional space recognition unit 111 to acquire three-dimensional space information indicating the arrangement of the object in the real space, the distance from the imaging device 1 to an object, and the like, and stores the three-dimensional space information in the primary storage unit 104.

In S1103, the control unit 101 acquires the camera position (X1, Y1, Z1), the necklace position (X2, Y2, Z2), and an orientation of the wearable device 2 using the information processing unit 102, and stores the acquired positions and orientation in the primary storage unit 104. The camera position (X1, Y1, Z1), the necklace position (X2, Y2, Z2), and the orientation of the wearable device 2 are acquired based on the three-dimensional space information stored in the primary storage unit 104.

In S1104, the control unit 101 uses the information processing unit 102 to determine the camera direction (direction 400 in FIG. 4) which is the direction from the wearable device 2(Necklace position, the object 3 in FIG. 4) to the imaging device 1 (camera position). The camera direction 400 is determined based on the camera position (X1, Y1, Z1), the necklace position (X2, Y2, Z2), and the orientation of the wearable device 2 stored in the primary storage unit 104.

Further, in S1104, the control unit 101 determines the imaging range 4 (a range having the position (X3, Y3, Z3) as the barycenter 401 (barycentric position)) of the imaging device 1 illustrated in FIG. 4 using the information processing unit 102. The imaging range 4 is determined based on the imaging conditions stored in the primary storage unit 104 and the camera position (X1, Y1, Z1).

Then, when the wearable device 2 (a necklace position, the object 3 in FIG. 4) is within the imaging range 4, the control unit 101 stores the camera direction 400 in the primary storage unit 104. On the other hand, when the wearable device 2 is not within the imaging range 4, the control unit 101 stores information indicating that there is no camera direction 400 in the primary storage unit 104 so that the camera direction 400 is not notified of.

In S1105, the control unit 101 transmits the camera direction 400 stored in the primary storage unit 104 to the wearable device 2 using the communication unit 103.

In S1107, the control unit 101 determines whether an ending operation that is a user operation of ending the operation of the imaging device 1 has been performed on the operation unit 108. When the ending operation has been performed, the operation of the imaging device 1 ends. Otherwise, the process proceeds to S1101.

Similarly to the imaging device 1, the operation of the wearable device 2 starts in response to the user operation on the operation unit 208 of the wearable device 2.

In S1115, the control unit 201 receives the camera direction 400 from the imaging device 1 using the communication unit 203, and stores the camera direction 400 in the primary storage unit 204.

In S1116, the control unit 201 notifies the object 3 wearing the wearable device 2 of the camera direction 400 stored in the primary storage unit 204 using the vibration unit 209.

In S1117, the control unit 201 determines whether the ending operation that is a user operation of ending the operation of the wearable device 2 has been performed on the operation unit 208. When the ending operation is performed, the operation of the wearable device 2 ends. Otherwise, the process proceeds to S1115.

As described above, according to the third embodiment, the camera direction is determined without using the GPS, and the object is notified of the camera direction by the vibration of the wearable device. In this way, even when a wearable device including no GPS receiver or the like is used, the object can easily ascertain the direction of the imaging device that captures the object by the vibration of the wearable device. Furthermore, the object can immediately perform an operation such as directing the line of sight to the imaging device or taking a pose.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, a user can easily ascertain a direction of an imaging device that captures an image of the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-180588, filed October 16, 2024, which is hereby incorporated by reference herein in its entirety.

What is claimed is:

1. An imaging system comprising:
an imaging device; and a wearable device,
wherein the imaging device or the wearable device is configured to execute a determination process of determining a camera direction that is a direction from the wearable device to the imaging device, and
wherein the imaging device or the wearable device is configured to execute a control process of performing control such that a user wearing the wearable device is notified of the camera direction by vibration of the wearable device in a case where the wearable device is within an imaging range of the imaging device.

2. The imaging system according to claim 1,
wherein, in the control process, control is performed such that a vibration pattern of the wearable device is changed in accordance with a distance from the wearable device to the imaging device.

3. The imaging system according to claim 1,
wherein the imaging device or the wearable device is configured to execute a detection process of detecting a state of the user, and
wherein, in a case where the state of the user is a predetermined state, in the control process, control is performed such that the user is not notified of the camera direction by the vibration of the wearable device.

4. The imaging system according to claim 3,
wherein the predetermined state includes at least one of a state in which the user is moving with intensity greater than a predetermined threshold, a state in which the user is sleeping, and a state in which the user is talking.

5. The imaging system according to claim 1,
wherein, in the control process, control is performed such that one or more of a plurality of notification methods including vibration of the wearable device is selected and the user is notified of the camera direction by the selected notification method.

6. The imaging system according to claim 5,
wherein the plurality of notification methods include at least one of output of a sound, display of an image, a change in temperature, and generation of an smell.

7. The imaging system according to claim 1,
wherein the imaging system includes the wearable device and a plurality of imaging devices, and
wherein, in a case where the wearable device is within an imaging range of each of the plurality of imaging devices, in the control process, control is performed such that the user is notified of at least one of a plurality of camera directions respectively corresponding to the plurality of imaging devices.

8. The imaging system according to claim 7,
wherein, in the control process, control is performed such that the user is notified of the plurality of camera directions by vibration of the wearable device in a plurality of vibration patterns respectively corresponding to the plurality of camera directions.

9. The imaging system according to claim 7,
wherein the imaging device or the wearable device is configured to execute a setting process of setting priority of each of the plurality of imaging devices, and
wherein, in the control process, control is performed such that the user is notified of a camera direction corresponding to an imaging device having priority higher than a predetermined threshold among the plurality of camera directions.

10. The imaging system according to claim 9,
wherein, in the setting process, the priority of the imaging device is set based on at least one of an instruction from the user, a distance from the wearable device to the imaging device, and a composition of an image captured by the imaging device.

11. The imaging system according to claim 1,
wherein the imaging range is a focus range.

12. The imaging system according to claim 1,
wherein, in a case where the imaging device is not capturing an image, in the control process, control is performed such that the user is not notified of the camera direction.

13. An imaging device in an imaging system comprising the imaging device and a wearable device,
wherein the imaging device or the wearable device is configured to execute a determination process of determining a camera direction that is a direction from the wearable device to the imaging device, and
wherein the imaging device is configured to execute a control process of performing control such that a user wearing the wearable device is notified of the camera direction by vibration of the wearable device in a case where the wearable device is within an imaging range of the imaging device.

14. A wearable device in an imaging system comprising an imaging device and a wearable device,
wherein the imaging device or the wearable device is configured to execute a determination process of determining a camera direction that is a direction from the wearable device to the imaging device, and
wherein the wearable device is configured to execute a notification process of notifying a user wearing the wearable device of the camera direction by vibration of the wearable device in a case where the wearable device is within an imaging range of the imaging device.

15. A control method of an imaging system including an imaging device and a wearable device, the control method comprising:
determining a camera direction that is a direction from the wearable device to the imaging device; and
performing control such that a user wearing the wearable device is notified of the camera direction by vibration of the wearable device in a case where the wearable device is within an imaging range of the imaging device.

16. A non-transitory computer readable medium that stores a program, wherein the program causes a computer to execute a control method of an imaging system including an imaging device and a wearable device, the control method comprising:
determining a camera direction that is a direction from the wearable device to the imaging device; and
performing control such that a user wearing the wearable device is notified of the camera direction by vibration of the wearable device in a case where the wearable device is within an imaging range of the imaging device.
